(19) United States
(12) Patent Application Publication
(10) Pub. No.: US 2026/0073120 A1
(43) Pub. Date: Mar. 12, 2026

(54) WEB PAGE PROCESSING METHOD AND BASE STATION

(71) Applicant: REALTEK SEMICONDUCTOR CORPORATION, HSINCHU (TW)

(72) Inventor: XIU-YUN XU, Suzhou (CN)

(21) Appl. No.: 19/319,936

(22) Filed: Sep. 5, 2025

(30) Foreign Application Priority Data
Sep. 9, 2024 (CN) 202411259372.6

(51) Int. Cl. G06F 40/123

(52) U.S. Cl. CPC G06F 40/123

(57) ABSTRACT

A web page processing method is applied in a base station, and the web page processing method includes: bonding a plurality of web pages to generate a bonded web page; splitting and compressing the bonded web page into a plurality of compressed data, and generating a corresponding relation table between the plurality of web pages and the plurality of compressed data; and storing the plurality of compressed data in a flash memory of the base station, and generating a corresponding location table related to the plurality of compressed data in the flash memory.

### BACKGROUND OF THE INVENTION

### 1. Field of the Invention

The present disclosure relates to a web page processing method and a base station, especially to a web page processing method and a base station that avoid inability to decompress data by splitting web page and storing compressed data in a distributed manner.

### 2. Description of Related Art

If an embedded system wants to provide web page services, web pages need to be compressed and then stored in a flash memory. Specifically, each of the web pages must be individually compressed and stored in the flash memory, and the storage location of each of the web pages must be recorded. When a web page access request from a user is received, the embedded system needs to decompress the requested web page. However, if the requested web page has a large amount of data, decompression requires a larger allocation of random access memory (RAM). If the random access memory of the embedded system is insufficient, the requested web page cannot be decompressed, resulting in a failed web page access.

### SUMMARY OF THE INVENTION

In some aspects, an object of the present disclosure is to, but not limited to, provides a web page processing method and a base station that make an improvement to the prior art.

An embodiment of a web page processing method of the present disclosure is applied in a base station. The web page processing method includes: bonding a plurality of web pages to generate a bonded web page; splitting and compressing the bonded web page into a plurality of compressed data, and generating a corresponding relation table between the plurality of web pages and the plurality of compressed data; and storing the plurality of compressed data in a flash memory of the base station, and generating a corresponding location table related to the plurality of compressed data in the flash memory.

An embodiment of a base station of the present disclosure includes a memory and a processor. The memory is configured to store a plurality of commands. The processor is configured to read the plurality of commands from the memory to execute: bonding a plurality of web pages to generate a bonded web page; splitting and compressing the bonded web page into a plurality of compressed data, and generating a corresponding relation table between the plurality of web pages and the plurality of compressed data; and storing the plurality of compressed data in a flash memory of the base station, and generating a corresponding location table related to the plurality of compressed data in the flash memory.

Technical features of some embodiments of the present disclosure make an improvement to the prior art. The base station and the web page processing method of the present disclosure adopt a bonding and splitting manner to distribute and compress the web page into a plurality of compressed data and store them in the flash memory. In this way, even if the amount of data of the web page that the user intends to access is relatively large, since the web page has already been distributed and compressed into a plurality of compressed data, the base station and the web page processing method of the present disclosure can sequentially decompress the compressed data (e.g., decompressing only one compressed data at a time). As a result, the amount of data that needs to be temporarily stored in the random access memory each time is reduced, thereby preventing the issue of failing to decompress data due to insufficient capacity in the random access memory.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a base station and an electronic device of the present disclosure.

FIG. 2 shows an embodiment of a flow diagram of a web page processing method of the present disclosure.

FIG. 3 shows an embodiment of operations of a web page processing method of the present disclosure.

FIG. 4 shows an embodiment of operations of a web page processing method of the present disclosure.

### DETAILED DESCRIPTION OF THE PREFERRED EMBODIMENTS

To address the issue in the prior art that insufficient random access memory in a system leads to a failure in decompressing a web page, resulting in a web page access failure, the present disclosure provides a web page processing method and a base station, which will be explained in detail as shown below.

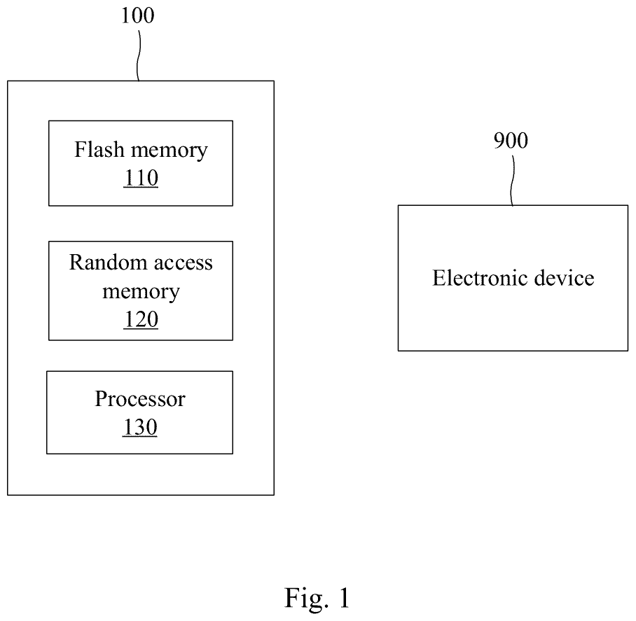

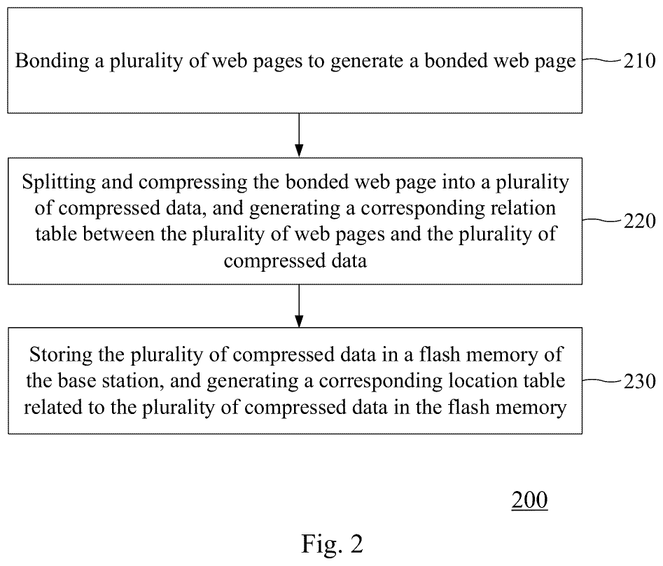

FIG. 1 shows an embodiment of a base station 100 and an electronic device 900 of the present disclosure. As shown in the figure, the base station 100 includes a flash memory 110, a random access memory (RAM) 120, and a processor 130. The flash memory 110 is configured to store a plurality of commands. The processor 130 is configured to read the plurality of commands from the flash memory 110 to execute corresponding operations. For facilitating the understanding of operations of the base station 100, reference is made to FIG. 2. FIG. 2 shows an embodiment of a flow diagram of a web page processing method 200 of the present disclosure.

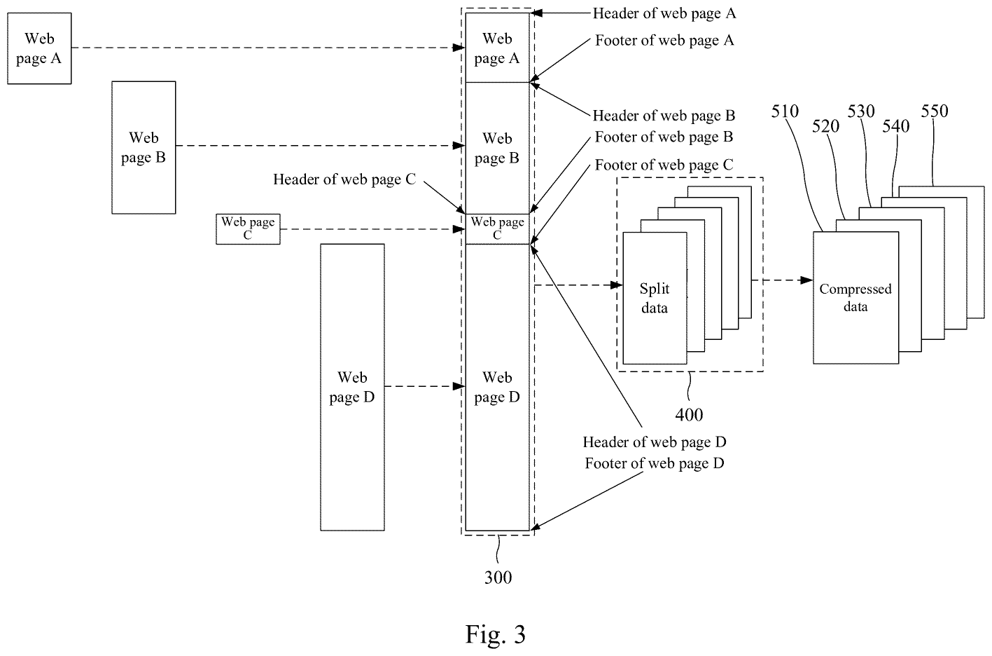

In step 210, bonding a plurality of web pages to generate a bonded web page. For example, referring to FIG. 3, a plurality of web pages A˜D are bonded to generate a bonded web page 300. However, the present disclosure is not limited to the above embodiment, which is merely configured to illustratively describe one of the implementations of the present disclosure. In other embodiments, the number and the size of the web pages in the present disclosure may adopt other suitable value and size depending on actual requirements.

In step 220, splitting and compressing the bonded web page into a plurality of compressed data, and generating a corresponding relation table between the plurality of web pages and the plurality of compressed data. For example, referring to FIG. 3, the bonded web page 300 is split and compressed to generate a plurality of compressed data 510˜550, and generate a corresponding relation table between the plurality of web pages A˜D and the plurality of compressed data 510˜550. In some embodiments, the corresponding relation table can be stored in the flash memory 110 for use in subsequent processes. However, the present disclosure is not limited to the above embodiment, which is merely configured to illustratively describe one of the implementations of the present disclosure. In other embodiments, the number of the compressed data in the present disclosure may adopt other suitable value depending on actual requirements.

In some embodiments, the step 220 in FIG. 2 includes the following steps: splitting the bonded web page into a plurality of split data; compressing the plurality of split data into the plurality of compressed data; and generating the corresponding relation table according to a plurality of corresponding relations between the plurality of web pages and the plurality of compressed data. For example, referring to FIG. 3, the bonded web page 300 is split into a plurality of split data 400. Subsequently, the plurality of split data 400 are compressed into the plurality of compressed data 510˜550. Next, the corresponding relation table is generated according to a plurality of corresponding relations between the plurality of web pages A˜D and the plurality of compressed data 510˜550. For example, the web page A corresponds to the compressed data 510, the web page B corresponds to the compressed data 520, the web page C corresponds to the compressed data 530, and the web page D corresponds to the compressed data 540, 550. However, the present disclosure is not limited to the above embodiment, which is merely configured to illustratively describe one of the implementations of the present disclosure. In other embodiments, the corresponding relation between the web page and the compressed data in the present disclosure may adopt other suitable corresponding manner depending on actual requirements.

In some embodiments, the bonded web page is equally divided into the plurality of split data. For example, referring to FIG. 3, the processor 130 can be configured to equally divide the bonded web page 300 into the plurality of split data 400. Subsequently, the plurality of split data 400 are compressed into the plurality of compressed data 510˜550. In some embodiments, the size of each of the plurality of compressed data 510˜550 is approximately 32KB (kilobytes). For example, the size of the compressed data 510 is approximately 32KB, the size of the compressed data 520 is approximately 32KB, and so on. However, the present disclosure is not limited to the above embodiment, which is merely configured to illustratively describe one of the implementations of the present disclosure. In other embodiments, the compressed data of the present disclosure may adopt other suitable size depending on actual requirements.

Referring to FIG. 2, in step 230, storing the plurality of compressed data in a flash memory of the base station, and generating a corresponding location table related to the plurality of compressed data in the flash memory. For example, referring to FIG. 3, the plurality of compressed data 510˜550 are stored in the flash memory 110, the processor 130 will generate a corresponding location table related to the plurality of compressed data 510˜550 in the flash memory 110 according to locations related to the plurality of compressed data 510˜550 in the flash memory 110.

In some embodiments, the step 230 in FIG. 2 includes the following step: generating the corresponding location table and a corresponding size table according to a plurality of corresponding locations related to the plurality of compressed data in the flash memory and a plurality of corresponding sizes. For example, referring to FIG. 3, the processor 130 is configured to receive a plurality of corresponding locations and a plurality of corresponding sizes related to the plurality of compressed data 510˜550 in the flash memory 110. Subsequently, the processor 130 can be configured to generate the corresponding location table according to the plurality of corresponding locations related to the plurality of compressed data 510˜550 in the flash memory 110, and generate a corresponding size table according to a plurality of corresponding sizes related to the plurality of compressed data 510˜550 in the flash memory 110. In some embodiments, the corresponding location table can be stored in the flash memory 110, and the corresponding size table can also be stored in the flash memory 110 for use in subsequent processes.

In some embodiments, the web page processing method 200 further includes the following steps: parsing a web page of the plurality of web pages that a web page access request intends to access; querying at least one compressed data of the plurality of compressed data corresponding to the web page according to the corresponding relation table; querying at least one location of the at least one compressed data according to the corresponding location table; and decompressing the at least one compressed data from the at least one location of the flash memory to generate at least one web page data, and outputting the at least one web page data. For example, referring to FIG. 1, when a user accesses a web page through the electronic device 900, the electronic device 900 will output a web page access request to the base station 100. The processor 130 of the base station 100 parses the web page access request and determines that the web page that the user intends to access is the web page A in FIG. 3. Next, the processor 130 queries that the web page A corresponds to the compressed data 510 according to the corresponding relation table. Subsequently, the processor 130 queries the location related to the compressed data 510 in the flash memory 110 according to the corresponding location table. Furthermore, the processor 130 decompresses the compressed data 510 from the location in the flash memory 110 to generate web page data corresponding to the web page A, and outputs the web page data to the electronic device 900 that issued the web page access request. Next, when the electronic device 900 receives the web page data corresponding to the web page A, the electronic device 900 processes the web page data and displays the web page A on the electronic device 900.

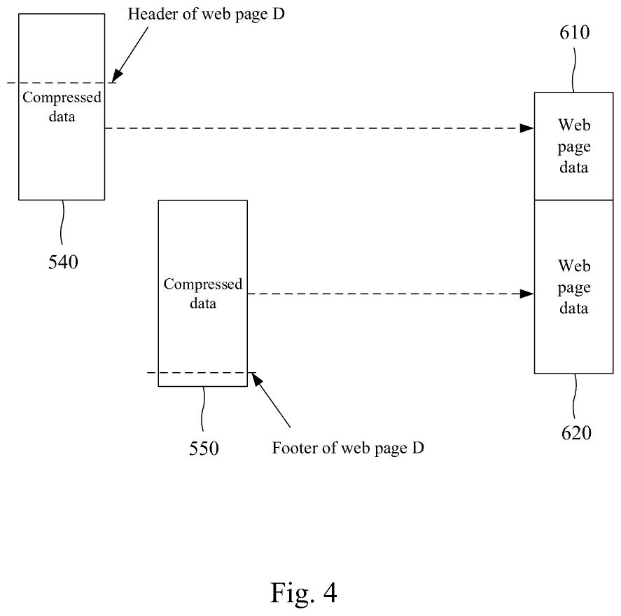

In some embodiments, referring to FIG. 3, the bonded web page 300 includes a plurality of headers and a plurality of footers of the plurality of web pages A˜D. The web page processing method 200 in FIG. 2 includes: reading at least two compressed data from at least two locations of the flash memory; decompressing the at least two compressed data according to the plurality of headers and the plurality of footers to generate at least two web page data; and outputting the at least two web page data. For example, referring to FIG. 4, the processor 130 reads the compressed data 540, 550 from at least two locations of the flash memory 110. Next, the processor 130 decompresses the compressed data 540, 550 according to the header and the footer of the web page D to generate at least two web page data 610, 620 corresponding to the web page D. Subsequently, the processor 130 outputs the at least two web page data 610, 620. Next, when the electronic device 900 receives the at least two web page data 610, 620 corresponding to the web page D, the electronic device 900 processes the at least two web page data 610, 620 and displays the web page D on the electronic device 900. However, the present disclosure is not limited to the above embodiment, which is merely configured to illustratively describe one of the implementations of the present disclosure. In other embodiments, the size of the web page data in the present disclosure may adopt other suitable size depending on actual requirements.

In some embodiments, the web page processing method 200 in FIG. 2 further includes the following steps: parsing a web page of the plurality of web pages that a web page access request intends to access; querying at least two compressed data of the plurality of compressed data corresponding to the web page according to the corresponding relation table; querying at least two locations of the at least two compressed data according to the corresponding location table; and decompressing the at least two compressed data from the at least two locations of the flash memory to generate at least two web page data, storing the at least two web page data to a random access memory of the base station, and outputting the at least two web page data from the random access memory. For example, referring to FIG. 1, when the user accesses the web page through the electronic device 900, the electronic device 900 will output a web page access request to the base station 100. The processor 130 of the base station 100 will parse the web page access request, and determine that the web page which the user intends to access is the web page D. Then, the processor 130 will query that the web page D in FIG. 3 corresponds to the compressed data 540, 550 according to the corresponding relation table. Subsequently, the processor 130 will query the locations related to the compressed data 540, 550 in the flash memory 110 according to the corresponding location table. Furthermore, the processor 130 will decompress the compressed data 540, 550 from the locations of the flash memory 110 to generate at least two web page data corresponding to the web page D, store the at least two web page data to the random access memory 120, and output the at least two web page data from the random access memory 120 to the electronic device 900 that issued the web page access request. After the electronic device 900 receives the at least two web page data corresponding to the web page D, the electronic device 900 will process the at least two web page data and display the web page D on the electronic device 900.

In some embodiments, the size of the flash memory 110 can be 2MB (megabytes), and the size of the random access memory 120 can be 8MB. However, the present disclosure is not limited to the above embodiment, which is merely configured to illustratively describe one of the implementations of the present disclosure. In other embodiments, the flash memory 110 and the random access memory 120 may adopt other suitable sizes depending on the actual needs. It should be noted that, even if the size of the random access memory 120 is only 8MB, the base station 100 and the web page processing method 200 of the present disclosure, through bonding and splitting the web page, distribute and compress the web pages A˜D into the plurality of compressed data 510˜550 and store them in the flash memory 110. In this way, even if the amount of data of the web page (e.g., the web page D) that the user intends to access is relatively large, since the web page (e.g., the web page D) has already been distributed and compressed into the plurality of compressed data 540, 550, the base station 100 and the web page processing method 200 of the present disclosure can sequentially decompress the compressed data 540, 550 (e.g., decompressing only one compressed data among the compressed data 540, 550 at a time). As a result, the amount of data that needs to be temporarily stored in the random access memory 120 each time is reduced, thereby preventing the issue of failing to decompress data due to insufficient capacity in the random access memory 120.

In some embodiments, the web page processing method 200 further includes the following steps: decompressing a first compressed data of the at least two compressed data from a first location of the at least two locations of the flash memory to generate a first web page data; storing the first web page data to the random access memory; outputting the first web page data from the random access memory to an electronic device that issues the web page access request; decompressing a second compressed data of the at least two compressed data from a second location of the at least two locations of the flash memory to generate a second web page data; storing the second web page data to the random access memory; and outputting the second web page data from the random access memory to the electronic device that issues the web page access request.

For example, the processor 130 respectively decompresses the at least two compressed data 510, 520 from the at least two locations of the flash memory 110 to generate first web page data and second web page data. Subsequently, the processor 130 respectively stores the first web page data and the second web page data to the random access memory 120. Next, the processor 130 respectively outputs the first web page data and the second web page data from the random access memory 120 to the electronic device 900 that issues the web page access request. After the electronic device 900 receives the first web page data and the second web page data, the electronic device 900 processes the web page data and displays the web page on the electronic device 900.

In some embodiments, the base station 100 can be an Access Point (AP). The electronic device 900 can be a smartphone, a laptop, a tablet, or other electronic products. However, the present disclosure is not limited to the above embodiment, which is merely configured to illustratively describe one of the implementations of the present disclosure. In other embodiments, the base station 100 and the electronic device 900 can be other suitable electronic products depending on the actual needs.

It should be noted that the present disclosure is not limited to the embodiments as shown in FIG. 1 to FIG. 4, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

In view of the above, the base station 100 and the web page processing method 200 of the present disclosure adopt a bonding and splitting manner to distribute and compress the web pages A˜D into the plurality of compressed data 510˜550 and store them in the flash memory 110. In this way, even if the amount of data of the web page (e.g., the web page D) that the user intends to access is relatively large, since the web page (e.g., the web page D) has already been distributed and compressed into the plurality of compressed data 540, 550, the base station 100 and the web page processing method 200 of the present disclosure can sequentially decompress the compressed data 540, 550 (e.g., decompressing only one compressed data among the compressed data 540, 550 at a time). As a result, the amount of data that needs to be temporarily stored in the random access memory 120 each time is reduced, thereby preventing the issue of failing to decompress data due to insufficient capacity in the random access memory 120.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A web page processing method, applied in a base station, comprising:
bonding a plurality of web pages to generate a bonded web page;
splitting and compressing the bonded web page into a plurality of compressed data, and generating a corresponding relation table between the plurality of web pages and the plurality of compressed data; and
storing the plurality of compressed data in a flash memory of the base station, and generating a corresponding location table related to the plurality of compressed data in the flash memory.

2. The web page processing method of claim 1, wherein splitting and compressing the bonded web page into the plurality of compressed data, and generating the corresponding relation table between the plurality of web pages and the plurality of compressed data comprises:
splitting the bonded web page into a plurality of split data;
compressing the plurality of split data into the plurality of compressed data; and
generating the corresponding relation table according to a plurality of corresponding relations between the plurality of web pages and the plurality of compressed data.

3. The web page processing method of claim 2, wherein splitting the bonded web page into the plurality of split data comprises:
equally dividing the bonded web page into the plurality of split data.

4. The web page processing method of claim 1, wherein storing the plurality of compressed data in the flash memory of the base station, and generating the corresponding location table related to the plurality of compressed data in the flash memory comprises:
generating the corresponding location table and a corresponding size table according to a plurality of corresponding locations related to the plurality of compressed data in the flash memory and a plurality of corresponding sizes.

5. The web page processing method of claim 1, further comprising:
storing the corresponding relation table in the flash memory.

6. The web page processing method of claim 1, further comprising:
storing the corresponding location table in the flash memory.

7. The web page processing method of claim 1, further comprising:
parsing a web page of the plurality of web pages that a web page access request intends to access;
querying at least one compressed data of the plurality of compressed data corresponding to the web page according to the corresponding relation table;
querying at least one location of the at least one compressed data according to the corresponding location table; and
decompressing the at least one compressed data from the at least one location of the flash memory to generate at least one web page data, and outputting the at least one web page data.

8. The web page processing method of claim 7, wherein the bonded web page comprises a plurality of headers and a plurality of footers of the plurality of web pages, wherein decompressing the at least one compressed data from the at least one location of the flash memory to generate the at least one web page data, and outputting the at least one web page data comprises:
reading at least two compressed data from at least two locations of the flash memory;
decompressing the at least two compressed data according to the plurality of headers and the plurality of footers to generate at least two web page data; and
outputting the at least two web page data.

9. The web page processing method of claim 1, further comprising:
parsing a web page of the plurality of web pages that a web page access request intends to access;
querying at least two compressed data of the plurality of compressed data corresponding to the web page according to the corresponding relation table;
querying at least two locations of the at least two compressed data according to the corresponding location table; and
decompressing the at least two compressed data from the at least two locations of the flash memory to generate at least two web page data, storing the at least two web page data to a random access memory of the base station, and outputting the at least two web page data from the random access memory.

10. The web page processing method of claim 9, wherein decompressing the at least two compressed data from the at least two locations of the flash memory to generate the at least two web page data, storing the at least two web page data to the random access memory of the base station, and outputting the at least two web page data from the random access memory comprises:
decompressing a first compressed data of the at least two compressed data from a first location of the at least two locations of the flash memory to generate a first web page data;
storing the first web page data to the random access memory;
outputting the first web page data from the random access memory to an electronic device that issues the web page access request;
decompressing a second compressed data of the at least two compressed data from a second location of the at least two locations of the flash memory to generate a second web page data;
storing the second web page data to the random access memory; and
outputting the second web page data from the random access memory to the electronic device that issues the web page access request.

11. A base station, comprising:
a memory, configured to store a plurality of commands; and
a processor, configured to read the plurality of commands from the memory to execute:
bonding a plurality of web pages to generate a bonded web page;
splitting and compressing the bonded web page into a plurality of compressed data, and generating a corresponding relation table between the plurality of web pages and the plurality of compressed data; and
storing the plurality of compressed data in a flash memory of the base station, and generating a corresponding location table related to the plurality of compressed data in the flash memory.

12. The base station of claim 11, wherein splitting and compressing the bonded web page into the plurality of compressed data, and generating the corresponding relation table between the plurality of web pages and the plurality of compressed data which is executed by the processor comprises:
splitting the bonded web page into a plurality of split data;
compressing the plurality of split data into the plurality of compressed data; and
generating the corresponding relation table according to a plurality of corresponding relations between the plurality of web pages and the plurality of compressed data.

13. The base station of claim 12, wherein splitting the bonded web page into the plurality of split data which is executed by the processor comprises:
equally dividing the bonded web page into the plurality of split data.

14. The base station of claim 11, wherein storing the plurality of compressed data in the flash memory of the base station, and generating the corresponding location table related to the plurality of compressed data in the flash memory which is executed by the processor comprises:
generating the corresponding location table and a corresponding size table according to a plurality of corresponding locations related to the plurality of compressed data in the flash memory and a plurality of corresponding sizes.

15. The base station of claim 11, wherein the processor is further configured to execute:
storing the corresponding relation table in the flash memory.

16. The base station of claim 11, wherein the processor is further configured to execute:
storing the corresponding location table in the flash memory.

17. The base station of claim 11, wherein the processor is further configured to execute:
parsing a web page of the plurality of web pages that a web page access request intends to access;
querying at least one compressed data of the plurality of compressed data corresponding to the web page according to the corresponding relation table;
querying at least one location of the at least one compressed data according to the corresponding location table; and
decompressing the at least one compressed data from the at least one location of the flash memory to generate at least one web page data, and outputting the at least one web page data.

18. The base station of claim 17, wherein the bonded web page comprises a plurality of headers and a plurality of footers of the plurality of web pages, wherein decompressing the at least one compressed data from the at least one location of the flash memory to generate the at least one web page data, and outputting the at least one web page data which is executed by the processor comprises:
reading at least two compressed data from at least two locations of the flash memory;
decompressing the at least two compressed data according to the plurality of headers and the plurality of footers to generate at least two web page data; and
outputting the at least two web page data.

19. The base station of claim 11, wherein the processor is further configured to execute:
parsing a web page of the plurality of web pages that a web page access request intends to access;
querying at least two compressed data of the plurality of compressed data corresponding to the web page according to the corresponding relation table;
querying at least two locations of the at least two compressed data according to the corresponding location table; and
decompressing the at least two compressed data from the at least two locations of the flash memory to generate at least two web page data, storing the at least two web page data to a random access memory of the base station, and outputting the at least two web page data from the random access memory.

20. The base station of claim 19, wherein decompressing the at least two compressed data from the at least two locations of the flash memory to generate the at least two web page data, storing the at least two web page data to the random access memory of the base station, and outputting the at least two web page data from the random access memory which is executed by the processor comprises:
decompressing a first compressed data of the at least two compressed data from a first location of the at least two locations of the flash memory to generate a first web page data;
storing the first web page data to the random access memory;
outputting the first web page data from the random access memory to an electronic device that issues the web page access request;
decompressing a second compressed data of the at least two compressed data from a second location of the at least two locations of the flash memory to generate a second web page data;
storing the second web page data to the random access memory; and
outputting the second web page data from the random access memory to the electronic device that issues the web page access request.
